(19) United States
(12) Patent Application Publication
(10) Pub. No.: US 2009/0022560 A1
(43) Pub. Date: Jan. 22, 2009

(54) Cutting or Parting Tool

(75) Inventor: Gerhardt Liemke, Hovelhof (DE)

Correspondence Address: BARNES & THORNBURG LLP, 750-17TH STREET NW, SUITE 900, WASHINGTON, DC, 20006-4675, US

(73) Assignee: DEUDIAM Diamantwerkzeuge und Maschinen GmbH, Hovelhof (DE)

(21) Appl. No.: 11/462,255

(22) Filed: Aug. 8, 2008

(30) Foreign Application Priority Data
Aug. 5, 2005 (DE) 20 2005 012 311.0

(51) Int. Cl. B28D 1/12; C09K 3/14

(52) U.S. Cl. 408/144; 51/309; 408/145; 407/118

(57) ABSTRACT

A cutting or parting tool including at least one cutting tooth connected with a basic element. The cutting tooth has a layer of carbide or of a mixture of carbide and polycrystalline diamonds. Furthermore, the carbide or mixture layer is connected to a carrier element of the cutting tooth made of a weldable material which is welded to the basic element.

The present invention relates to a cutting or parting tool according to the preamble of claim 1.

Such cutting or parting tools are used in different fields. The parting and/or cutting of stone or concrete is mentioned here as an example. In this case, the used cutting or parting tools are constructed as cutoff wheels, annular bits, particularly annular core bits, or the like.

The cutting teeth, with which the cutting or parting tools are equipped, have a layer of carbide, preferably metal carbide or a mixture of carbide and diamonds, so-called polycrystalline diamonds (PCD).

In this case, the cutting teeth are material-fittingly, normally by means of soldering, preferably hard-soldering, connected with a basic element consisting of steel, which is used as a carrier for the cutting teeth and is constructed as a disk or as a can when used as an annular bit.

The connection of the cutting teeth with the basic element by means of soldering, which so far had been the only possibility, has considerable disadvantages, particularly with respect to the service life of the cutting or parting tool.

Because of the relatively high operating temperatures, which arise during the cutting or parting, in connection with the high endured stress cycles caused by the vibratory strain occurring during the operation, the soldered joints do not represent connections which meet the requirements with respect to an optimal service life of the cutting or parting tool.

Thus, the cutting teeth break off relatively frequently as a result of the above-mentioned stress, which makes the cutting or parting tool useless. Often a repair, specifically the insertion of new cutting teeth, is not possible, and if it is, it can only be carried out by means of considerable labor expenditures. In each case, the service life restricted to this extent results in costs which stand in the way of an economically meaningful use.

Specifically taking into account that such cutting and parting tools are used in large quantities, the described circumstance is particularly significant.

It is therefore an object of the present invention to further develop a cutting or parting tool of the above-mentioned type such that it can be produced in a simple and cost-effective manner and its service life is considerably increased.

This object is achieved by means of a cutting or parting tool having the characteristics of claim 1.

A cutting or parting tool constructed in this manner is distinguished particularly by its significantly higher stability under load with respect to the joints between the cutting teeth and the basic element.

As a result of welding the cutting teeth to the basic element, the cutting and parting tools can be used for a significantly longer time period than those according to the state of the art, without any impairments of the junctions between the cutting teeth and the basic element.

In addition to the cost-minimizing increase of the service life, another remarkable advantage to be stressed is that a new cutting or parting tool can be produced in a very simple manner at low production-related expenditures. In this case, the welded connection of each cutting tooth with the basic element takes place by laser welding which can essentially be implemented by means of an automatic operating sequence.

The carrier element consisting of a weldable material, preferably steel, is intimately connected with the layer of carbide or a mixture of carbide and polycrystalline diamonds such that a detachment of this connection cannot take place even under extreme operating conditions with respect to pressure and temperature. This applies in the same manner to the welding of the carrier element to the basic element, which normally also consists of steel.

The production of the cutting tooth, that is, the connection of the above-mentioned layers with the carrier element takes place in the sense of a sintering by means of a high pressure and at a high temperature.

As mentioned above, the actual cutting element may consist of metal carbides, such as chromium, tungsten, molybdenum, vanadium, or the like. This cutting layer is then connected directly with the carrier element.

Instead, it is also possible to use only polycrystalline diamonds (PCD) as the cutting layer, which is connected with a carbide layer which, in turn, is carried by the carrier element.

In order to achieve a certain toughness of the cutting layer, the latter may consist of a mixture of polycrystalline diamonds and carbides, which then are connected with the carrier element either directly or by way of an intermediate layer of carbide.

The mixture ratios between the carbides and the polycrystalline diamonds are dependent on the respective demands on the cutting elements.

The carrier element which, as mentioned above, preferably consists of steel, may naturally also be formed of another weldable material, including diverse steel alloys whose selection is also dependent on the stresses which differ depending on the usage.

In addition to the above-mentioned laser welding, naturally other welding methods are also conceivable, by means of which the cutting teeth are fastened to the basic element, the suitability being mainly determined by the permitted efficient production.

Additional advantageous constructions of the invention are characterized in the subclaims.

In the following, an embodiment of the invention will be described by means of the attached drawings.

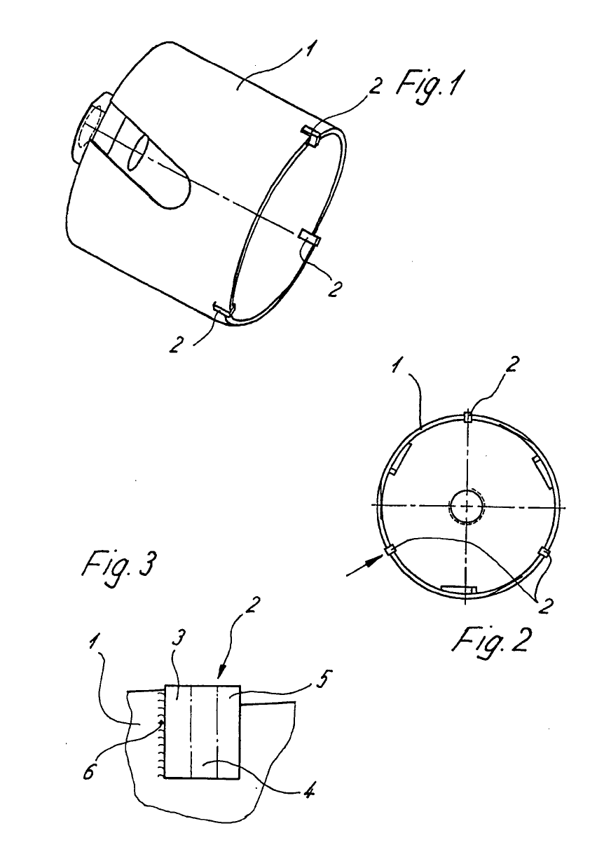

FIG. 1 is a perspective view of a cutting or parting tool according to the invention;

FIG. 2 is a top view of the cutting or parting tool;

FIG. 3 is a lateral view of a partial cutout of the cutting or parting tool.

FIGS. 1 and 2 illustrate a cutting or parting tool in the form of an annular bit which can be clamped into a drilling machine, not shown, and which has a can-shaped basic element 1 made of a weldable material, preferably steel.

On its open face, the basic element 1 has several, in the present embodiment, three cutting teeth 2 which are situated at an identical angular distance from one another and which are sunk into the front edge of the basic element 1 and are firmly connected with the latter, a cutting edge of a cutting layer 5 being exposed for the cutting or parting.

According to the invention, each cutting tooth 2 has a carrier element 3 made of a weldable material, preferably steel, with which a metal carbide layer 4 is undetachably connected, which carrier element 3, in turn, carries the cutting layer 5 consisting of polycrystalline diamonds, which cutting layer 5 is also undetachably connected with the metal carbide layer 4.

In the area of its contact surface on the basic element 1, the carrier element 3 is welded to the basic element 1. In FIG. 3, the weld seam has the reference number 6.

In this case, the carrier element 3 can be welded in the area of its entire contact surface to the basic element 1; that is, in the area of the illustrated weld seam as well as in the contact area on the base of a recess of the basic element 1, in which the plate-shaped cutting tooth 2 is disposed.

1. The cutting or parting tool according to claim 3, wherein the carbide layer is connected with the carrier element by a sintering.

2. The cutting or parting tool according to claim 3, including a cutting layer of one of polycrystalline diamonds and of a mixture of polycrystalline diamonds and metal carbides is undetachably connected with the carbide layer on a side facing away from the carrier element.

3. A cutting or parting tool, having at least one cutting tooth connected with a basic element, the cutting tooth comprising: a layer of carbide, undetachably connected to a carrier element made of a weldable material; and the cutting tooth being connected at the carrier element to the basic element by a weld.

4. The cutting or parting tool according to claim 3, wherein the carrier element is formed of steel or steel alloys.

5. The cutting or parting tool according to claim 3, wherein the carrier element is welded to the basic element in a partial area of the contact with the basic element.

6. The cutting or parting tool according to claim 3, wherein the carrier element is welded to the basic body element in the entire contact air with the basic element.

7. The cutting or parting tool according to claim 3, wherein the carrier element is connected with the basic element by a laser weld.
